(19) United States
(12) Patent Application Publication
(10) Pub. No.: US 2010/0289362 A1
(43) Pub. Date: Nov. 18, 2010

(54) ELECTRIC MOTOR WITH ULTRASONIC NON-CONTACT BEARING

(75) Inventors: Serhiy Petrenko, Kiev (UA); Valentin Rangelov Zhelyaskov, Sarasota, FL (US)

Correspondence Address: FOX ROTHSCHILD LLP;PRINCETON PIKE CORPORATE CENTER, 997 LENOX DRIVE, BLDG. #3, LAWRENCEVILLE, NJ, 08648, US

(73) Assignee: Discovery Technology International, LLLP

(21) Appl. No.: 12/781,618

(22) Filed: May 17, 2010

Related U.S. Application Data
(60) Provisional application No. 61/178,587, filed on May 15, 2009.

(51) Int. Cl. H02K 7/08; H02P 31/00

(52) U.S. Cl. 310/90; 318/558

(57) ABSTRACT

A piezoelectric ultrasonic suspension in gas for creating a contactless bearing support of a precision instrument and specifically an electromagnetic motor. A gas micro-film of elevated pressure is formed between the adjoining surfaces of a spherical saddle and a spherical trunnion. The spherical trunnion is spaced apart from the spherical surface of a saddle by a gas micro-film when the piezoresonator is excited.

### CROSS REFERENCES TO RELATED APPLICATIONS

This application claims priority to U.S. Patent Application Ser. No. 61/178,587 filed May 15, 2009, which is hereby incorporated by reference in its entirety.

### FIELD OF THE INVENTION

The invention relates to the field of electric motors with non-contact bearings, and more particularly to motors with non-contact bearings that can be used for providing suspension of sensitive components.

### BACKGROUND

Brushless motors operating on direct or alternating current are well known in the art. Such motors typically comprise a brushless acceleration unit, which includes a stator and a rotor, and an axial system. In the conventional synchronous or asynchronous brushless motors, the stator windings generate a rotating electromagnetic field. The rotating electromagnetic field interacts with the electromagnetic field of the rotor windings or with the permanent magnet field of the rotor, which creates a torque on the motor rotor. The rotor is installed on an axis which is fixed by bearings. Usually these are plain or rolling-element bearings.

While such brushless motors are well known, they are also recognized as having several disadvantages. For example, such motors are known to have a limited service life defined by the life-time of the bearings. Brushless electric motors are also known to produce significant levels of vibration and noise due to the characteristics of the bearing. The significant vibration levels in particular are recognized as greatly limiting the operational characteristics of the motor, such as its speed.

Some problems associated with brushless electric motors are partially eliminated in motors that operate on the principle of non-contact support. For example, various electrostatic, magnetic, and superconducting contactless suspensions/supports have been suggested. See for example, Kasatkin, A. S. New types of gyroscopes. Leningrad: Sudostroenie, 1971, p. 9 and p. 31 The operating principle of these devices resides in creating forces of either electrostatic or magnetic repulsion between a saddle and a corresponding trunnion.

A shortcoming of motors incorporating the various electrostatic, magnetic, and superconducting contactless suspensions/supports is the significant technological difficulty involved in their implementation. This has contributed to relatively poor technical specifications and performance for motors of this type. For example, such motors tend to have relatively low load-bearing capacity, produce adverse torques, and involve complicated stabilization in space on account of considerable gaps and so on. The technological difficulties associated with such motors has also resulted in devices which have relatively high cost. Accordingly, motors incorporating these principles have failed to find broad application in commercial practice.

There are also known in the art various devices based on the formation of three-axis contactless ultrasonic supports. Such devices are discussed for example in Ukraine Patent No. 4169 to Petrenko, et al. which concerns a design for a gas-bearing precision instruments, and in USSR Patent No. 1782316 to Petrenko, et al. for a reliance precision instrument. However, these reference are generally limited to various generic supports as opposed to motors arrangements.

Also known in the art are non-contact support systems that involve a gas support or bearing employed in a gas-dynamic gyroscope. See, e.g. Proceedings of the VII St-Petersburg International Conference on Integrated Navigation Systems, St. Petersburg, 2000, pp. 106-110. These systems are based on the idea of creating a gas micro-film of elevated pressure between the adjoining or conjugate surfaces of the saddle and of the trunnion. The elevated pressure area in this method is created owing to the dynamic characteristics of the gas stream formed in the gap between the adjoining surfaces of a gas turbine (saddle)-trunnion assembly.

Among the disadvantages of the gas support systems are significant technological complications related to the formation of a gas stream with the required dynamic parameters. For example, the requisite gas stream formation involves the complex configuration of the gap between the adjoining surfaces, the turbine design, and the requirement for highly stable turbine rotation. Other problems with the gas stream approach include: the inability to use that method in static mode, such as when the turbine/trunnion are immobile); the high energy demand (specifically when the system goes from static condition to movement); the inadequate three-axis stability of the support due to the considerable gap between the adjoining surfaces (as large as 1 mm for some designs) and fluctuation of the gas stream; significant gas-dynamic drag torques of such supports (as as high as 10−3 g·cm); jerky motion; and the high cost of such supports/bearings. Moreover, gas supported motors are known to be difficult to stabilize, which in many cases requires significant and careful rotor balancing, especially when working at high rotation speeds. Specifically, the rotors in such systems need to be well balanced to avoid “beating” effect, which is characterized by jerky movement of the axis of rotation in various directions during the rotation. This happens when the center of mass does not coincide with the axis of rotation.

### SUMMARY

The invention concerns a low-cost self-centering motor which embodies a novel physical principle, with improved technical specifications, including improvements in drag torque, consumed power, specific load-bearing capacity, and three-axis stability of the support. The motor utilizes a piezoelectric ultrasonic suspension in gas for creating a contactless bearing support of a precision instrument and specifically an electromagnetic motor. This is accomplished by forming a gas micro-film of elevated pressure between the adjoining surfaces of a spherically curved saddle of a bearing support and a corresponding spherically curved trunnion. The bearing support includes an annular saddle defining a portion of a concave spherical surface. A trunnion defines a portion of a convex spherical surface configured for rotating within the annular saddle. In effect, the annular saddle forms a conjugated surface with respect to at least a portion of the surface of the trunnion.

A piezoresonator element is rigidly attached to the bearing support for generating the gas micro-film. When no exciter signal is applied to the piezoelectric element, the trunnion is in contact with the saddle along the conjugated surface of a spherical zone defined by each of the saddle and the trunnion.

The piezoelectric element is attached to a base, on which the stator of the electrical motor is mounted. A rotor-shaft is fixed to the trunnion, while the resulting center of mass of the rotor and the trunnion is advantageously located below the center of curvature of the saddle. The piezoelectric element is configured to be electrically connected to an excitation generator.

Resonant ultrasonic waves are excited in the saddle. Consequently, radiation acoustic pressure is applied to the conjugate surface of the trunnion by formation of a directed ultrasonic acoustic field. The directed ultrasonic acoustic field is formed by the conjugate surface of the saddle and by formation of a standing acoustic wave in the gap between the adjoining surfaces of the saddle and the trunnion. As a result, a working gap between the adjoining surfaces is created due to opposing forces created by the radiation acoustic field and the forces associated with the load-bearing capacity of the bearing support.

According to one aspect, the rotor is a brushless rotor comprising at least one permanent magnet. The at least one permanent magnet can define an annular magnetic ring. More particularly, the rotor can be comprised of a symmetric magnetic ring installed on the trunnion symmetrically aligned with respect to an axis of rotation of the trunnion. The magnetic ring is located in a plane containing a center of curvature defined by the convex spherical surface of the trunnion and perpendicular to the axis of rotation of the trunnion.

A stator is axially aligned with the rotor under certain conditions and is configured for producing an angular acceleration in the rotor. Further the stator is configured for producing a rotating magnetic field when the stator is energized. The stator is located in a plane containing the center of curvature and perpendicular to an axis of symmetry defined by the saddle. In some embodiments, the stator is located inside the rotor. In other embodiments, the rotor is located inside the stator.

The piezoresonator can be formed as a flat annular piezoresonator ring having a polarization vector aligned with an axis of rotation of the rotor. The piezoresonator can be in contact with the bearing support along an entire planar surface defined by a face of the annular piezoresonator ring. According to some aspects of the invention, the cylindrical profile surface of the bearing support is in contact with the conjugate cylindrical profile surface of the piezoresonator. In such cases, the piezoresonator has a polarization vector aligned with an annular radius of the piezoresonator.

The invention also includes a generator for generating an exciter signal for the piezoresonator. If the motor is configured with the piezoresonator in contact with the bearing support along planar face of the annular piezoresonator ring, then a generator frequency corresponds to the natural frequency of the first order radial mode of the piezoresonator element or the natural frequency of the zero order flexural mode of the bearing support. Alternatively, if the motor is configured with the bearing support in contact with the conjugate cylindrical profile surface of the piezoresonator, then the generator frequency corresponds to the natural frequency of the first order radial mode of the piezoresonator element or the natural frequency of the zero order flexural mode of the bearing support. The invention also concerns a method for operating a motor. The method includes producing an angular acceleration in a brushless rotor of a motor in response to a rotating magnetic field provided by a stator. Responsive to the angular acceleration in the brushless rotor, a rotation is imparted in a trunnion attached to the rotor, the trunnion having a convex spherical surface configured for rotating within a concave spherical surface of a saddle formed in a bearing support. The method also includes the step of using a piezoresonator to generate a gas micro-film between the convex spherical surface and the concave spherical surface. The generating step further comprises forming a spherical high order standing acoustic wave in a gaseous layer defined between the concave spherical surface of the saddle and the convex spherical surface of the trunnion.

According to one aspect of the invention, the method can include vertically stabilizing a rotation axis of the rotor by selecting a center of mass of a rotor assembly to be located below a center of curvature of the saddle, the rotor assembly including a trunnion, the rotor, a magnetic ring attached to the rotor, and at least one working element.

The method can further include exciting the piezoresonator with an exciter signal having a frequency which corresponds to the natural frequency of a first order radial mode of the piezoresonator element or the natural frequency of the zero order flexural mode of the bearing support. Alternatively, the method can include exciting the piezoresonator with an exciter signal having a frequency which corresponds to the first order radial mode of the piezoresonator element or the natural frequency of the zero order flexural mode of the bearing support.

### BRIEF DESCRIPTION OF THE DRAWINGS

Embodiments will be described with reference to the following drawing Figures, in which like numerals represent like items throughout the figures, and in which:

FIG. 1 is a cross-sectional view of a simplified schematic of a motor that is useful for understanding the invention.

FIG. 2 is a cross-sectional view showing a simplified schematic of the motor in FIG. 1, with a relative displacement of the base planes and axes of the stator and the rotor at a certain deviation from the vertical direction when there is static or dynamic imbalance.

FIG. 3 shows a physical model of suspension-pendulum mass m with a point of suspension “OR” and length of suspension L, equal to the radius of curvature of a trunnion.

FIG. 4 is a cross-sectional view of a simplified motor schematic that is useful for understanding an alternative embodiment of the invention in which a bearing support is in contact with an annular piezoresonator element along its cylindrical surface.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

The inventive arrangements provide a non-contact ultrasonic suspension of the three-dimensional rotor of an electric motor, due to the creation of an elevated-pressure gas microfilm between the conjugated surfaces of a saddle (serving as a contactless bearing) and a trunnion (which is part of a rotor assembly). As used herein, the unitary term “conjugated surfaces” refers to a pair of surfaces that have certain features in common, such as spherical shape and radius of curvature, but which otherwise form an opposite or inverse pair. Thus, opposing concave and convex surfaces of the saddle and the trunnion will sometimes be referred to herein as conjugate surfaces.

The gas microfilm between the conjugated surfaces as described herein serves to completely eliminate mechanical contact between the saddle and the trunnion. The absence of such contact substantially decreases the friction between the rotor and its support (saddle). For example, the frictional forces can be reduced two to three orders of magnitude since the remaining friction is determined only by the friction of the rotor with air or other gas in the gap between the trunnion (rotor) and the saddle (rotor support). This arrangement provides a potentially unrestricted life-time of the motor. Furthermore, elimination of mechanical contact makes the rotor movement very smooth, thereby eliminating any jerky motion. Damping of any oscillations of the rotor by the inherent resilience of the elevated-pressure gas microfilm minimizes the level of vibration and noise.

The motor comprises a single three-dimensional support, meaning that the position of the rotor assembly is controlled in the three dimensions. The support ensures that the motor axis of rotation in a free state (with the suspension system activated) maintains a vertical orientation. After the angular acceleration of the rotor is initiated, the axis of rotation stabilizes itself in space. If the center of mass lies on the center of symmetry of the rotor, the axis of rotation will coincide with the vertical axis. If the center of mass is not on the center of symmetry of the rotor (as would be the case where there exists an unbalanced load), the axis of rotation will not coincide with the vertical axis. The rotor behaves as if it freely “floats” in the support, and with “acceleration” initiated, it spins and stabilizes itself like a whip-top.

The ultrasonic non-contact suspension of the rotor is provided by means of a standing acoustic wave that is maintained in the gaseous layer defined by the adjoining or conjugated surfaces of the saddle and the trunnion. The acoustic pressure of the standing wave provides the load-bearing capacity of the support. The “floating” axis effect is achieved by means of the contactless three-dimensional support of the rotor assembly which has a center of mass displaced relative to a virtual suspension point.

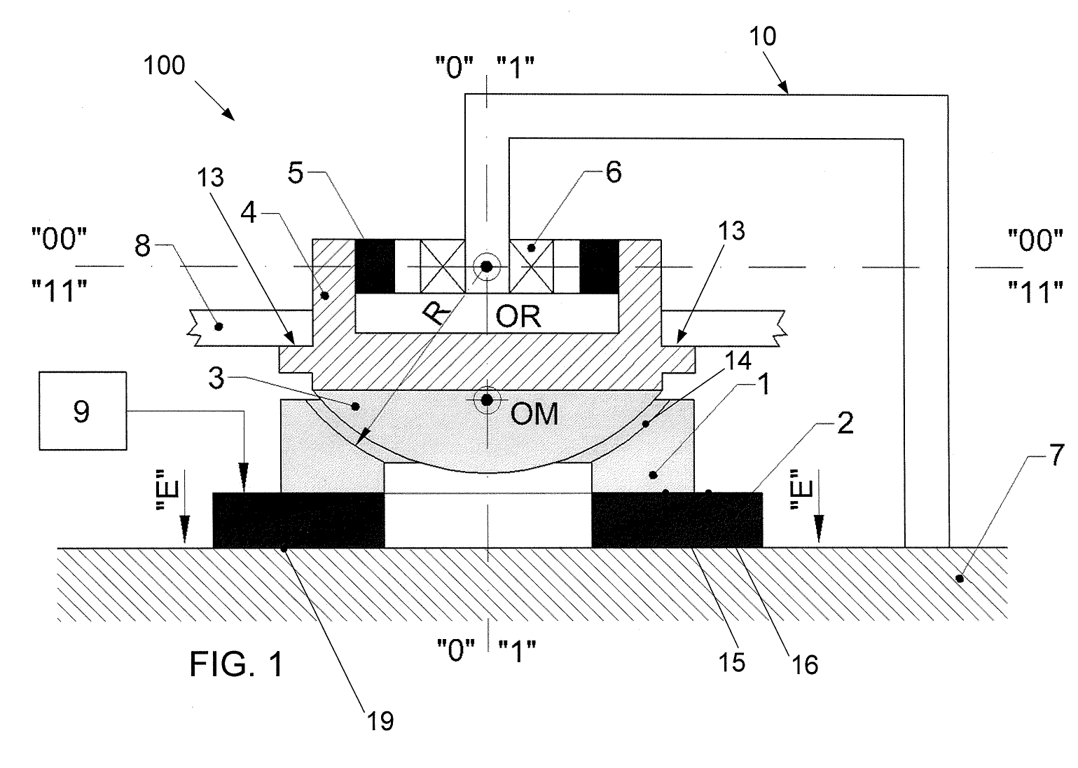

Referring now to FIG. 1, there is shown a simplified schematic of a motor 100 that is useful for understanding the invention. This motor comprises a non-contact spherical suspension and a brushless acceleration unit. The contactless spherical suspension includes an ultrasonic non-contact bearing support 1, including a saddle 14 which defines a concave spherical surface with a radius of curvature R and with an axis of symmetry “0-0”. The bearing support can advantageously have an annular shape defining a cylindrical outer surface.

The bearing support 1 is rigidly attached to a piezoresonator 2 which has a polarization vector “E”. Those skilled in the art will appreciate that this vector defines the direction the electrical excitation of the piezoresonator will be applied, namely aligned with the vector E. Piezoresonator 2 is a piezoelectric element and can be formed of any suitable material now known or determined in the future to have a piezoelectric characteristic. Suitable materials for this purpose can include without limitation piezoceramics selected from the group of piezoelectric lead-zirconate-titanate-strontium ceramics (PZT) materials. A generator 9 is electrically connected with the electrical contacts of piezoresonator 2

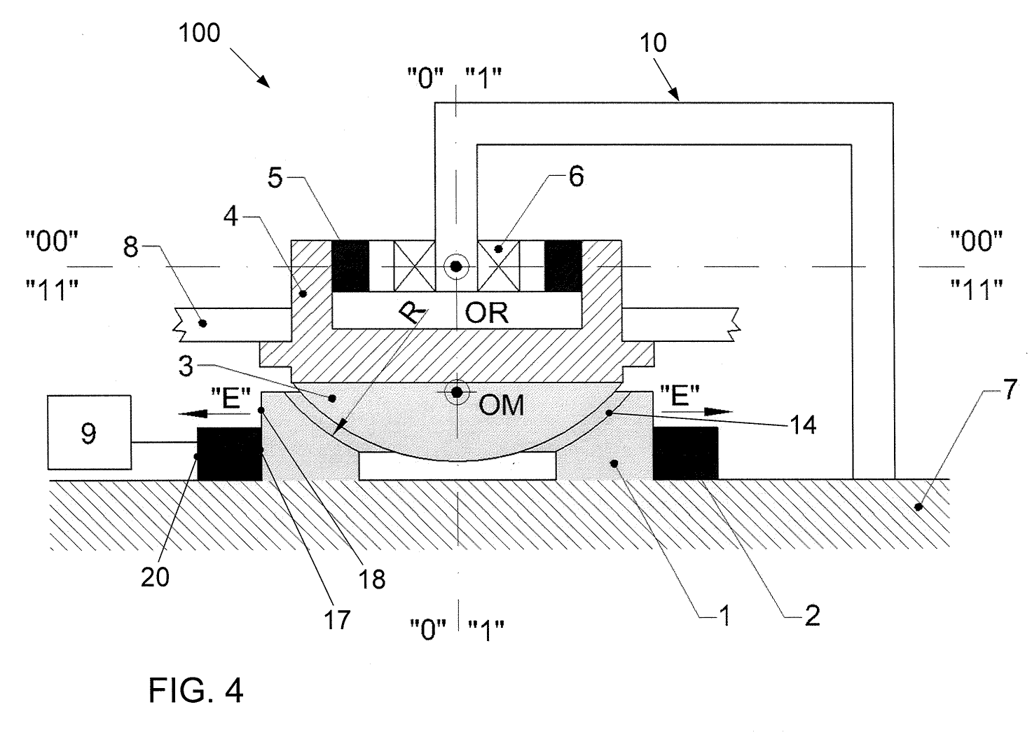

According to one embodiment, the piezoresonator 2 and the bearing support 1 can each have an annular form. In the embodiment of the invention shown in FIG. 1, a flat face 15 of the annular bearing support 1 can engage a planar face 16 of the piezoresonator. In other embodiments shown in FIG. 4, a cylindrical surface 17 defined by the annular form of the piezoresonator 2 can be configured as a conjugate surface with respect to the cylindrical surface 18 defined by the bearing support 1. Consequently a surface of the piezoresonator 2 can snugly engage the bearing support 1. Excitation electrodes (not shown) are positioned on the upper and lower planar faces 16, 19 of the annular piezoresonator ring in the configuration shown in FIG. 1. The excitation electrodes are positioned on the inside and outside cylindrical surfaces 17, 20 of the annular piezoresonator ring shown in FIG. 4.

The saddle 14 engages a spherical convex trunnion 3 (with an axis of symmetry “1-1”). The trunnion 3 has the same radius of curvature R as the spherical saddle. The trunnion 3 carries a rotor 4 with a drive element including at least one permanent magnet arranged so as to form an annular magnetic ring 5. A stator 6 is secured to the base 7 by suitable means. For example a cantilevered support arm 10 can be used for this purpose. Still, the invention is not limited in this regard and other support structures can be used without limitation. In some embodiments of the invention, the trunnion and the bearing support can be made of glass, pyroceramic, or glass-ceramic. However, the invention is not limited in this regard and any other suitable material can also be used for this purpose.

The rotor 4 has a plurality of seats 13 for receiving working elements 8. The working elements can be any structure useful for performing a motor driven function. For example, the working elements 8 can be fan blades, optical or magnetic sensors without limitation. The combination of the rotor 4, magnetic ring 5, working elements 8 and trunnion 3 is referred to herein as the rotor assembly.

The motor 100 is advantageously configured so that the center of mass OM of the rotor assembly (including rotor 4, magnetic ring 5, working elements 8 and trunnion 3) is located below the center of curvature of the saddle “OR” with radius R. The acceleration magnetic ring 5 is positioned in the diametric plane “11-11” of the trunnion 3. The stator 6 is situated symmetrically in the diametric plane “00-00” of the saddle 1, perpendicular to its axis “0-0”.

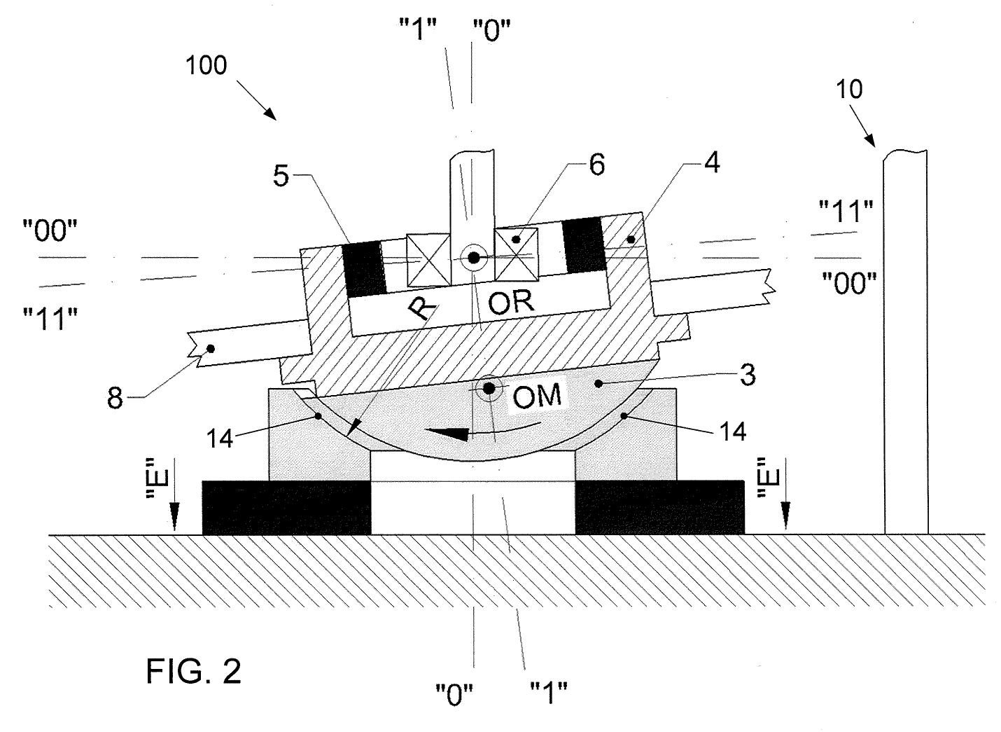

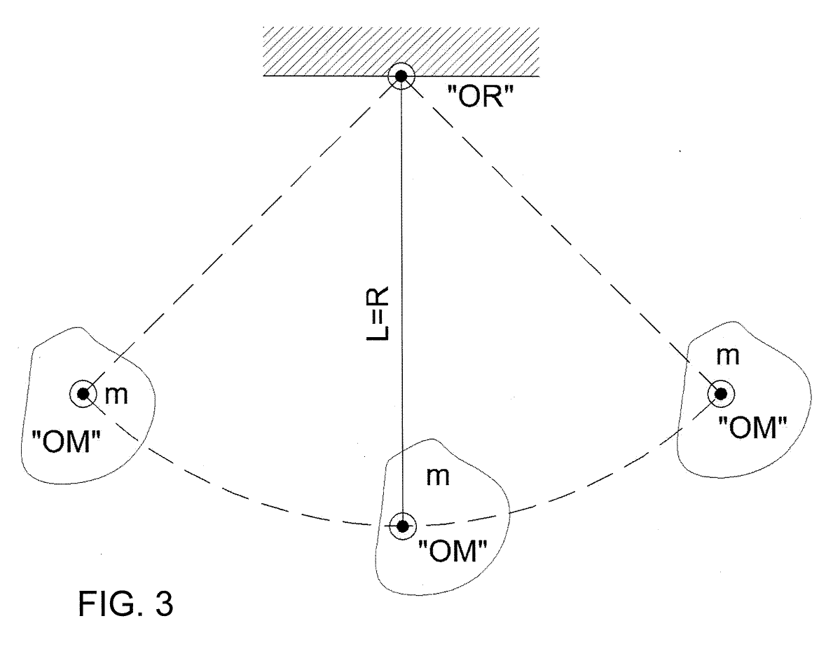

FIG. 2 shows a simplified schematic of the relative displacement of the base planes and axes of the stator (“0-0”, “00-00”) and the rotor (“1-1”, “11-11”) at a certain deviation of the axes of the rotor from the vertical direction when there is static or dynamic imbalance. FIG. 3 shows a physical model of suspension-pendulum mass m (where m is the resultant mass of the rotor assembly) with a point of suspension “OR” and length of suspension L, equal to the radius of curvature R of the saddle 14.

The theory of operation for the motor 100 shall now be described in further detail. A periodic AC voltage is supplied by generator 9 at frequency F. For example, the periodic wave could be a sine wave. If the motor is configured as shown in FIG. 1, with the piezoresonator 2 in contact with the bearing support 1 along planar face 16 of the annular piezoresonator ring, then a generator frequency F is advantageously selected so as to correspond to the frequency of first order radial mode of the piezoresonator 2 or the natural frequency of the zero order flexural mode of the bearing support 1, if they are not the same. In this case, the electric field provided by the excitation signal is applied to the side walls 16, 19 of the piezoresonator along its thickness, perpendicular to the plane which contains the piezoresonator and the first order radial vibrations. This results in expansion and contraction of the piezoresonator in the direction of its thickness. However, because of the elasticity of the piezoresonator, when the thickness of the piezoresonator wall changes with frequency F, the first order radial mode of vibration is excited as well.

Alternatively, if the motor 100 is configured as shown in FIG. 4, with the bearing support in contact with the conjugate cylindrical profile surface of the piezoresonator, then the generator frequency F is advantageously selected so as to correspond to the frequency of the first order radial mode of the piezoresonator 2 or the natural frequency of the zero order flexural mode of the bearing support 1, if they are not the same. In this case, the excitation frequency is applied directly to the inner and outer cylindrical walls 17, 20 of the piezoresonator 2, which promotes a direct excitation of the first order radial mode, which is in the same plane as the piezoresonator. In other words, the piezoresonator expands and contracts in the radial direction. Still, the invention is not limited in this regard, and other frequencies can also be used.

The frequency F is selected so as to correspond to the natural frequency of the piezoresonator 2 or the natural frequency of the first-order radial mode of the piezoresonator 2 or the natural frequency of the zero order flexural mode of the bearing support 1, if they are not the same. In this regard, the dimensions of the piezoresonator 2 and the bearing support 1 are preferably selected such that their natural frequencies are similar. For example, the natural frequency of each of the piezoresonator and the bearing support are preferably selected so that they do not differ by more than about 50%. According to some embodiments, the sine wave can have a frequency in the range of 20 kHz to 150 kHz. However, the invention is not limited in this regard and other frequencies can also be used. As a practical matter, the lower frequency used is preferably higher than the audio frequency range since it is generally not desirable to operate in the audio range. The upper limit is to some extent a function of the structure size. The frequency range given is suitable for structures as small as about 10 mm. Motors having smaller dimensions can operate at much higher frequencies. For example, such motors could be constructed with MEMS methods. The excitation signal from the generator 9 is conductively coupled to the excitation electrodes of the piezoresonator 2.

The application of the periodic AC voltage to the piezoresonator results in “extension-contraction” elastic deformations being induced in the piezoresonator due to an inverse piezoelectric effect. As a result of such piezoelectric effect, the vibrations of the piezoresonator are directed along the planar end surface of piezoresonator 2 where it is attached to the bearing support 1. With the piezoresonator 2 attached to the bearing support 1 as shown in FIG. 1, these elastic deformations are excited in the saddle 14 as well.

The elastic deformations produced in saddle 14 result in a standing flexural wave being established in the bearing support 1. As will be appreciated by those skilled in the art, a flexural wave involves a vibrational condition in which parts of a physical body can move in opposite directions during the vibration. The standing flexural wave is produced due to varying rigidity of the bearing support 1 along its diameter due to the varying height 14 of the saddle. This standing flexural wave causes “umbrella” vibrations in the saddle 14. In this case, the “umbrella' vibration is characterized by periodic changes in the radius of curvature of the concave shape of the saddle during the vibration as the bearing support expands and contracts in the radial direction.

As a result of such umbrella vibrations, the conjugated surface of the saddle 14 facing toward the trunnion 3 initiates micro-angular vibrations. More particularly, the conjugated surface of the saddle, owing to interaction with a gaseous medium, such as air, starts to generate a directed acoustic field toward the trunnion 3. As such, the conjugated surface of the saddle 14 becomes a source of an acoustic wave. A similar situation arises if the bearing support 1 is in contact along the cylindrical surface of the piezoresonator as shown in FIG. 4. However, in this case, to excite radial oscillations of the piezoresonator element a polarization “E” along the radius of the annular resonator is required.

While propagating in the gap between saddle 14 and trunnion 3, the acoustic wave produced by the conjugated surface of the saddle 14 becomes reflected by the similar convex surface of the trunnion 3. Consequently, a spherical high-order standing acoustic wave is formed in the gap. In this regard, the gap can be thought of as becoming a gaseous acoustic resonator. The radiation acoustic pressure of the spherical standing acoustic wave exerts force on the surface of the trunnion and the surface of the saddle where they are adjacent and opposed to each other. This radiation acoustic pressure provides the load-bearing capacity of the saddle 14. In this way, an ultrasonic suspension of the rotor 4 of the presented motor 1 is attained. The rotation of the rotor 4 can be initiated by formation of a rotating magnetic field on the coil of the stator 6, which interacts with the magnet ring 5 and produces a rotary torque applied to the working element of the electric motor.

One should not confuse ultrasonic non-contact suspension of the rotor herein with conventional ultrasonic “levitation” methods, since ultrasonic levitation, formed by an ultrasonic generator in the frequency range of 20-200 kHz is working at the gas film thickness of the order of several to several tens of millimeters. Such thickness is more than three orders of magnitude greater than in the proposed technical solution, in which the thickness is typically on the order of two or three microns, although the invention is not limited in this regard. The main reasons that the present invention is able to achieve this very small gas film thickness is that spherical wave generated in the gap between the trunnion and the saddle of the present invention is a high order wave (order at least greater than one). In contrast, such conventional ultrasonic levitation methods generally involve a first order standing wave. To be able to achieve the high order spherical wave in the current invention, the corresponding adjacent surfaces of the trunion and the saddle are manufactured to very high tolerances. For example, any imperfections in the conjugated surfaces defined by the saddle and the trunnion should be substantially less than the size of the gap between the trunnion and saddle. If the gap is expected to be 2 or three micros, then any irregularities or discontinuities in the conjugated surfaces should be substantially smaller than the gap size. This explains the high precision of the proposed system (stabilization of the axis of rotation with an accuracy in the micrometer range) that cannot be achieved with ultrasonic levitation.

In one embodiment shown in FIGS. 1, 2 and 4, the stator 6 can include a plurality of stator windings surrounding one or more permanent magnets forming magnetic ring 5. Methods for inducing rotation using such techniques are well known in the art and therefore will not be described here in detail. However, it should be understood that a plurality of windings of stator 6 can be selectively energized in accordance with a predetermined pattern or timing to provide the desired rotating magnetic field. A suitable controller and control circuitry can be used for such purpose as would be understood by one skilled in the art.

The controller performs essentially the same timed power distribution found in a brushed DC motor, but uses a solid-state circuit rather than a commutator/brush system. In a typical embodiment, the controller would contain a plurality of bi-directional drivers. These drivers are provided to drive high-current DC power, and are in turn controlled by a simple logic circuit or microcontroller. As will be appreciated by those skilled in the art, the logic circuit or microcontroller can be configured to manage motor acceleration, control speed and efficiency. The windings of the stator can be connected to each other in a delta configuration or a wye configuration, without limitation as is known in the art.

It should be understood that many different motor configurations are possible and all such configurations are intended to be included within the scope of the present invention. For example, in FIGS. 1, 2 and 4, the stator 6 is arranged inside the rotor 4. However, the invention is not limited in this regard. The configuration shown could also be reversed so that the rotor 4 is positioned inside the stator. These kinds of alternative arrangements are well known in the art. Still, the invention is not limited in this regard.

Stability and self-centering ability of the system is achieved due to the fact that the center of mass “OM of the resultant rotor mass <<m>>, acts as a pendulum (with a point of suspension “OR”, and length of suspension “L” equal “R”). This concept is illustrated in FIG. 3 in which the center of mass “OM” is shown in various positions relative to the center of curvature “OR”. The pendulum-like rotor thus defined by this embodiment results in the center of mass “OM” always tending to move to its lowest vertical position as shown in FIG. 1. In this position, all forces are at equilibrium. When deviated from this position (see FIGS. 2 and 3), the center of mass “OM” does not coincide with the axis of symmetry “1-1”. Consequently, the rotor will automatically adjust to a stable position. Significantly, when the center of mass is deviated from the axis of symmetry, the rotor will not come out of the field of the stator due to the fact that the center line “11-11” of the rotor synchronously moves with the magnetic ring 5 relative to the center “OR” of the stator. This feature is best observed in relation to FIG. 2. As a consequence of the foregoing arrangement, an angular acceleration is possible even when there is imbalance as in FIG. 2. In any case, the geometry of the motor is such that the system will quickly return to its dynamically balanced position.

The proposed motor 100 described herein comprises a single three-dimensional support, with the motor axis of rotation in a free state (with the suspension activated) acquiring a vertical position. This equilibrium position is achieved due to the motor 100 design in which the center of gravity lies below the “imaginary” point of suspension “OR”, which is determined by the center of curvature of the saddle. This arrangement places the stator 6 in a horizontal plane 00-00. After the angular acceleration of the rotor 4 is initiated, the axis 1-1 stabilizes itself in space. If the center of mass of the rotor assembly lies on the center of symmetry of the rotor, then the axis of rotation will coincide with the vertical axis. If the center of mass is not on the center of symmetry of the rotor (for example in the case of an unbalanced load), the axis of rotation will deviate from the vertical axis. Therefore, initially the proposed motor has an axis of rotation with three degrees of freedom and after the angular acceleration the axis stabilizes in space due to dynamic effects, i.e. gyroscopic effect.

The proposed type of electrical motor with “floating” axis is a new type of noiseless motor with a single three-dimensional contactless support and potentially unlimited service life. A distinctive feature of this motor is its low cost and manufacturability, as it excludes the need for an accurate initial alignment and adjustment, which is typical for the conventional single axis electrical motors. This makes it possible to establish mass production of such motors, without special set up for precision production as it requires only a standard spherical optical production capabilities and could use non-expensive brands of glass.

Applicants have presented herein certain theoretical aspects above that are believed to be accurate that appear to explain observations made regarding embodiments of the invention. However, embodiments of the invention may be practiced without the theoretical aspects presented. Moreover, the theoretical aspects are presented with the understanding that Applicants do not seek to be bound by the theory presented.

Further, while various embodiments of the present invention have been described above, it should be understood that they have been presented by way of example only, and not limitation. Numerous changes to the disclosed embodiments can be made in accordance with the disclosure herein without departing from the spirit or scope of the invention. For example, the various embodiments of the invention are not limited with regard to any particular type of materials described herein. Thus, the breadth and scope of the present invention should not be limited by any of the above described embodiments. Rather, the scope of the invention should be defined in accordance with the following claims and their equivalents.

While the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

In general, the terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

We claim:

1. A motor, comprising:
a bearing support including a saddle having an annular shape and defining a portion of a concave spherical surface;
a piezoresonator rigidly attached to said bearing support;
a trunnion defining a portion of a convex spherical surface configured for rotating within said saddle, said saddle forming a conjugated surface with respect to at least a portion of said trunnion;
a rotor provided on said trunnion;
a stator axially aligned with said rotor under certain conditions and configured for producing an angular acceleration in said rotor;
wherein said saddle is responsive to said piezoresonator for producing a spherical high order standing acoustic wave in a gaseous layer defined between conjugate spherical surfaces of said saddle and said trunnion.

2. The motor according to claim 1, wherein said trunnion is exclusively supported on said standing acoustic wave when said piezoresonator is excited.

3. The motor according to claim 2, wherein said trunnion is supported in three dimensions by said acoustic wave.

4. The motor according to claim 1, wherein said rotor is a brushless rotor comprising at least one permanent magnet.

5. The motor according to claim 1, wherein said at least one permanent magnet defines an annular magnetic ring.

6. The motor according to claim 1, wherein said stator is configured for producing a rotating magnetic field when said stator is energized.

7. The motor according to claim 1, wherein said convex spherical surface of said trunnion has the same radius of curvature as the concave spherical surface of said saddle.

8. The motor according to claim 1, further comprising at least one working element attached to said rotor and configured for performing a motor driven function.

9. The motor according to claim 8, wherein said trunnion, said rotor, a magnetic ring attached to said rotor, and said at least one working element, together comprise a rotor assembly and a center of mass of the rotor assembly is located below a center of curvature of the saddle.

10. The motor according to claim 1, wherein said piezoresonator is rigidly attached to said bearing support on a surface opposed from said saddle.

11. The motor according to claim 10, wherein said piezoresonator is formed as an annular-shaped piezoelectric ring having a polarization vector aligned with an axis of rotation of said rotor.

12. The motor according to claim 11, wherein said piezoresonator is in contact with said bearing support along an entire planar surface defined by a face of said annular-shaped piezoelectric ring.

13. The motor according to claim 1, wherein said rotor is comprised of a magnetic ring installed on the trunnion symmetrically with respect to an axis of rotation of the trunnion.

14. The motor according to claim 13, wherein said magnetic ring is axially aligned with said axis of rotation, and located in a plane containing a center of curvature defined by said convex spherical surface of said trunnion and perpendicular to said axis of rotation of said trunnion.

15. The motor, according to claim 14, wherein the stator is located in a plane containing said center of curvature and perpendicular to an axis of symmetry defined by said saddle.

16. The motor according to claim 1, wherein said stator is located inside a diameter of the rotor.

17. The motor according to claim 1, wherein said rotor is located inside a diameter of the stator.

18. The motor according to claim 1, wherein said bearing support has a cylindrical profile surface, and said piezoresonator has a conjugate cylindrical profile.

19. The motor according to claim 1, wherein said cylindrical profile surface of said bearing support is in contact with said conjugate cylindrical profile surface.

20. The motor according to claim 18, wherein said piezoresonator has an annular form and has a polarization vector aligned with a radius of the piezoresonator.

21. The motor according to claim 1, further comprising a generator for generating an exciter signal for said piezoresonator.

22. The motor according to claim 21, wherein said generator is configured to generate an exciter signal having a frequency which corresponds to the natural frequency of the first order radial mode of the piezoresonator element or the natural frequency of the zero order flexural mode of the bearing support by applying the excitation signal to the side walls of the piezoresonator along its thickness.

23. The motor according to claim 21, wherein said generator is configured to generate an exciter signal having a frequency which corresponds to the natural frequency of the first order radial mode of the piezoresonator element or a natural frequency of the zero order flexural mode of the bearing support by applying the excitation voltage directly to the external and internal cylindrical walls of the piezoresonator.

24. The motor according to claim 21, wherein the generator is configured to generate an excitation signal having a frequency in the range of 20-150 kHz.

25. The motor according to claim 21, wherein the natural frequency of the piezoresonator and the bearing support do not differ by more than 50%.

26. The motor according to claim 1, wherein each of the trunnion and the saddle are made of a material selected from the group consisting of glass, pyroceramic, or glass-ceramic.

27. A method for operating a motor, comprising:
producing an angular acceleration in a brushless rotor of a motor in response to a rotating magnetic field provided by a stator;
responsive to said angular acceleration in said brushless rotor, imparting a rotation in a trunnion attached to the rotor and having a convex spherical surface configured for rotating within a concave spherical surface of an annular saddle formed in a bearing support;
using a piezoresonator to generate a gas micro-film between said convex spherical surface and said concave spherical surface;
wherein said generating step further comprises forming a spherical high order standing acoustic wave in a gaseous layer defined between the concave spherical surface of said annular saddle and the convex spherical surface of said trunnion.

28. The method according to claim 27, further comprising exciting said piezoresonator with an exciter signal having a frequency which corresponds to the natural frequency of a first order radial mode of the piezoresonator element or the natural frequency of the zero order flexural mode of the bearing support by applying the excitation voltage to the side walls of the piezoresonator along its thickness.

29. The method according to claim 27, further comprising exciting said piezoresonator with an exciter signal having a frequency which corresponds to the first order radial mode of the piezoresonator element or a natural frequency of the zero order flexural mode of the bearing support by applying the excitation voltage directly to the external and internal walls of the piezoresonator.

30. The method according to claim 27, further comprising vertically stabilizing a rotation axis of said rotor by selecting a center of mass of a rotor assembly to be located below a center of curvature of the saddle, said rotor assembly including a trunnion, said rotor, a magnetic ring attached to said rotor, and at least one working element.
